(19) United States
(12) Patent Application Publication
(10) Pub. No.: US 2026/0225034 A1
(43) Pub. Date: Aug. 6, 2026

(54) Atmospheric Water Generation Systems Encompassing Hygroscopic Media and Methods of Using the Same

(71) Applicant: Genesis Systems LLC, Tampa, FL (US)

(72) Inventors: David James STUCKENBERG, Tampa, FL (US); Venkateswara Rao KODE, Tampa, FL (US); Owen Michael ERICKSON, Largo, FL (US); Erick Keith Went, Camarillo, CA (US)

(21) Appl. No.: 19/150,786

(22) PCT Filed: Jan. 29, 2024
(86) PCT No.: PCT/US2024/013309

§ 371 Date: Jul. 24, 2025

Related U.S. Application Data
(60) Provisional application No. 63/442,350, filed on Jan. 31, 2023.

(51) Int. Cl. B01D 53/26; B01D 53/14

(52) U.S. Cl. CPC B01D 53/263; B01D 53/1425; B01D 2257/80

(57) ABSTRACT

An atmospheric water generation system comprises an absorption chamber configured to facilitate absorption or adsorption of water from atmospheric or ambient air into and/or onto a hygroscopic media, and a separation vessel in fluid communication with the absorption chamber for extraction of absorbed or adsorbed water from the hygroscopic media. A method of producing clean water using the atmospheric water generation system and a method for generating water from moisture-laden gas are described in this disclosure.

### RELATED APPLICATION

The present patent document claims the benefit of priority under 35 U.S.C. 119(e) to U.S. Provisional Patent Application No. 63/442,350, which was filed on Jan. 31, 2023, and is hereby incorporated by reference in its entirety.

### TECHNICAL FIELD

The present disclosure is related generally to atmospheric water generation, and more particularly to a system and method for atmospheric water generation utilizing hygroscopic media.

### BACKGROUND

Standard atmospheric water generation (AWG) systems have faced challenges including high energy demands associated with multiple water phase transitions to produce a unit of water, among other. Water vapor is first extracted from air, typically into an intermediary fluid, such as a liquid desiccant. The water vapor is then extracted from the intermediary fluid into liquid water through another highly energy intensive process. Other systems use direct cooling to cool the water vapor to the dew point and extract liquid water on a cooled surface. Several attempts have been made to bring down the overall energy requirements of AWG systems; however, energy-reduction techniques remain limited by their feasibility for all-weather AWG conditions. Thus, alternative innovative technologies that generate water in an energy-efficient manner are sought.

### BRIEF DESCRIPTION OF THE DRAWINGS

FIG. 1 shows a list of component ions that may represent the hygroscopic media.

FIG. 2 is a schematic of an exemplary atmospheric water generation (AWG) system illustrating a process for AWG.

FIGS. 3A and 3B illustrate the behavior of a hygroscopic media and water, where, at a temperature below the lower critical solution temperature (LCST), the hygroscopic media is soluble in the water and forms a homogeneous solution (FIG. 3A), and where, when heated to a temperature above the LCST, the homogeneous solution separates into a hygroscopic media phase comprising the hygroscopic media (at the bottom of the vial) and a water phase comprising the captured water (top of the vial), where the water phase and the hygroscopic media phase are immiscible (FIG. 3B); after cooling, a single homogenous phase forms again (FIG. 3A).

FIG. 4A is a top view schematic of a plurality of separators (configured as centrifugation units) undergoing centrifugation.

FIG. 4B is a cross-sectional schematic of one of the centrifugation units, which may be employed as an alternative to a settling tank for separation of the hygroscopic media from the captured water.

FIG. 5 is a cross-sectional schematic of a separator configured for pressure-driven membrane separation.

FIGS. 6A and 6B are schematics showing exemplary configurations of AWG systems.

### DETAILED DESCRIPTION

Hygroscopic media that can, in a first step, absorb water from the air and, in a second step, desorb or release the water with minimal energy input are described in this disclosure, along with AWG systems that utilize the hygroscopic media. In sum, a primary objective is to utilize little to no energy to extract water out of the hygroscopic media. The focus on more recent research has been taking water out of the hygroscopic media to allow for recycling of the media in the water capture process. Otherwise, the hygroscopic media used to absorb the water cannot be re-used in a closed loop system. Closed loop systems may reduce cost, waste, and prevent harm to environment from loss of fluids, etc.

Compositions which are capable of adsorbing or absorbing water and are responsive to the input of energy or mixing with gases, as described below, may be referred to as hygroscopic media. Compositions responsive to the input of energy in particular (e.g., thermal energy) may be referred to as hygroscopic thermo-responsive media. Compositions responsive to mixing with particular gases may be referred to as hygroscopic gas-responsive media. In this disclosure, the terms “hygroscopic media,” “hygroscopic fluid,” “hygroscopic fluid media,” and “media” may be used interchangeably to refer to these compositions.

In use within an AWG system, energy input or output to a hygroscopic thermo-responsive media is thermal energy (heating or cooling of the thermo-responsive media) to raise or lower the temperature of the media. Either of two different categories of thermo-responsive media may be utilized in certain embodiments: upper critical solution temperature (UCST) media, and lower critical solution temperature (LCST) media. The critical solution temperature refers to point of pressure and temperature pairs above or below which a solution will no longer be in a two-phase liquid state. For USCT media, increasing the temperature above the solution critical temperature may result in the media forming a homogenous liquid phase. Decreasing the temperature below the USCT may result in a two-phase liquid-liquid separation where the two phases are in equilibrium with each other. Conversely, for LCST media, decreasing the temperature below the critical solution temperature may result in a homogenous liquid phase and increasing the temperature above the critical solution temperature may result in a two-phase liquid-liquid separation due to a negative entropy of mixing. The hygroscopic thermo-responsive media employed in this disclosure may exhibit a liquid-liquid phase separation when heated above LCST, due to a negative entropy of mixing. The energy required for separation of water from the media (i.e., enthalpy of demixing) is approximately 10 J/g, which is three orders of magnitude lower than the first-order phase transition of water that is prevalent in traditional thermal regeneration (2400 J/g). Additionally, a little energy input (as little as warmth in one's palms while holding a sample glass vial) in the form of sensible heat may be required to attain temperatures above the LCST for near zero energy separation of water from the hygroscopic thermo-responsive media, which can be coupled with a low-grade source such as solar-thermal energy. Once a two-phase liquid-liquid solution has been achieved by a change in energy, the desired phase can be extracted and utilized or processed for further purification.

To extract water out of liquid desiccant, one of the promising pathways is to utilize LCST-driven phase separation. Separation of a homogeneous hygroscopic aqueous solution into its constituent liquids via sensible heating obviates the need for vaporization/distillation and the associated latent heat of phase change. Therefore, it may enable alternative more energy efficient cycles in many applications such as atmospheric water harvesting, that involve the separation of miscible liquids during regeneration for water capture. LCST phase behavior of the hygroscopic thermo-responsive media is advantageous and can be typically controlled by properly selecting concentration, temperature, the choice of cation, anion, and solvent. The homogenous hygroscopic thermo-responsive media can be phase separated by applying a minimal temperature gradient for near zero energy separation of water from the media.

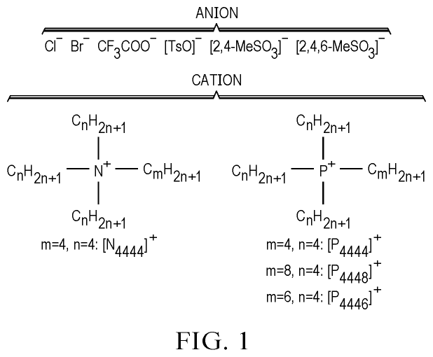

Selection of suitable hygroscopic media based on overall system design has the potential to minimize energy and capital cost, and this suggests a need to develop a framework for AWG that optimizes multiple material properties. To this end, it is beneficial to measure and obtain a mechanistic understanding of hygroscope media-water mixture properties as a function of concentration and temperature. These thermo-responsive and/or gas-responsive hygroscopic media may be used within AWG systems and methods. In some examples, the hygroscopic media may include ionic liquid(s), polymer(s), organic solvent(s), and/or brine solution(s). FIG. 1 shows a list of component ions that may represent the hygroscopic media. Constituents of the hygroscopic media, may include, in some examples, tetrabutylphosphonium bromide, tetrabutylphosphonium chloride, tetrabutylphosphonium trifluoroacetate, tributyl(octyl)phosphonium bromide, poly(N-isopropylacrylamide), 1-hexyl-3-methylimidazolium bromide, tributylhexylphosphonium bromide, 1,3-dimethylimidazolium iodide tetrabutylphosphonium 2,4 dimethylbenzenesulfonate, tetrabutylphosphonium trifluoroacetate, tetrabutylphosphonium mesitylene sulfonate, tributyloctylphosphonium bromide, tetrabutylphosphonium p-toluenesulfonate, tetrabutylphosphonium N-trifluoromethanesulfonyl leucine, and/or mixtures thereof. In certain embodiments, the hygroscopic fluid may include, but are not limited to, [N₄₄₄₄][TMBS], [N₄₄₄₄]CF₃COO, [P₄₄₄₄][Sal], [P₄₄₄₄][SS], [N₄₄₄₄]CF₃COO, [P₄₄₄₄][Mal], and/or mixtures thereof. In certain embodiments, the hygroscopic media incorporated herein may comprise other materials including, but not limited to, colloids, nanomaterials, and/or a combination thereof for enhancing process efficiency.

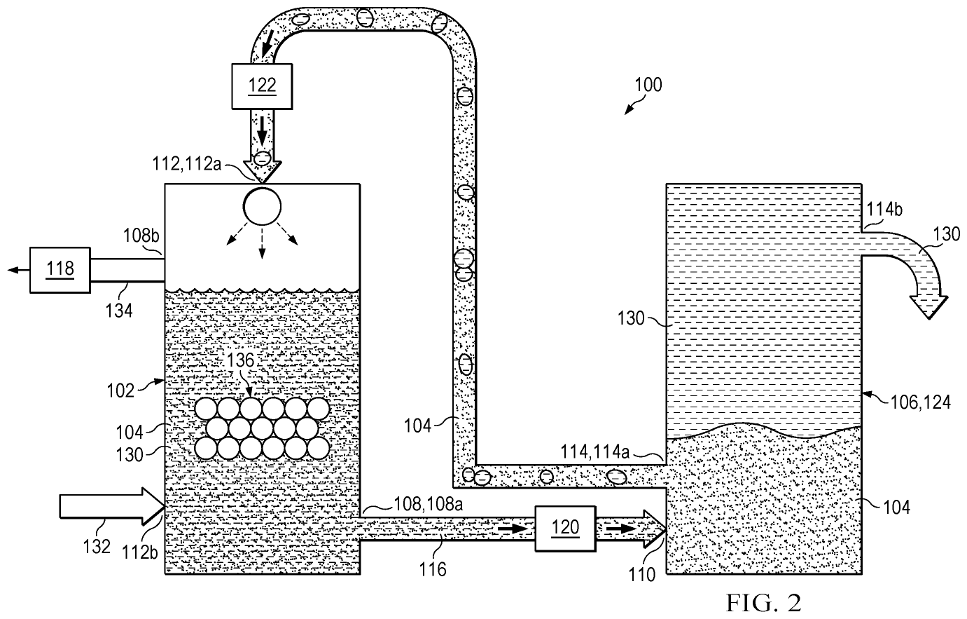

FIG. 2 is a schematic of an exemplary atmospheric water generation system showing a process for AWG. Various embodiments are directed to an AWG system 100 that utilizes hygroscopic media 104 to absorb water 130 from air (e.g., to absorb water vapor within atmospheric air 132) and to make the absorbed water 130 usable as clean, liquid water. Specifically, certain embodiments are directed to any of a variety of liquid-liquid extraction processes (by separating the hygroscopic media 104 from water 130 diluting the hygroscopic media) that utilizes heating and/or cooling of the hygroscopic media 104 to encourage water absorption (e.g., in an absorber or absorption chamber 102) and water extraction. The dry air 134 may then exit the absorber 102 back to the atmosphere. In certain embodiments, certain gases may be extracted from air (e.g., after extracting water vapor from air) in a gas extraction stage 118. In certain embodiments, the captured dry air 134 may be allowed to pass through carbon capture modules in the gas extraction stage 118 prior to exhausting the dry, dehumidified air 134 to the surrounding environment, thereby establishing a negative carbon footprint for sustainable and circular economy development.

One embodiment comprises an absorption loop wherein the atmospheric or ambient air 132 is passed through an absorption chamber 102 configured to facilitate the absorption or adsorption of water 130 into or onto the hygroscopic media 104. In some embodiments, the hygroscopic media 104 entering the absorber 102 may have a weight percentage of about 5% to 95%. Bulk mass transfer of water 130 from ambient air 132 through the mechanisms of absorption and/or adsorption is accomplished by a difference in vapor pressure between the water 130 in air 132 (water vapor) and the vapor pressure of the hygroscopic media 104. In response to changes in energy, such as inputs of heat, electricity, kinetic energy, and/or the like (i.e., input or output of energy to the media 104) and/or the input and mixing of specific gases with the hygroscopic media 104, a two-phase liquid-liquid separation or extraction may occur.

Once water vapor 130 from the air 132 has been absorbed or adsorbed into or onto the hygroscopic media 104, what is referred to herein as a dilute hygroscopic media 116, or a water-laden hygroscopic media 116, may be formed. The dilute hygroscopic media 116 may be heated prior to, during, or after entering a separator 106 (e.g., settling tank 124). For instance, the dilute hygroscopic media 116 may be heated to a temperature above the LCST of the media, which may be concentration dependent, in an energy exchanging device 120. When the dilute hygroscopic media 116 is heated above the LCST, the fluid phase separates into the hygroscopic media 104 and captured water 130. In some embodiments, the dilute hygroscopic media is heated to a temperature of about under 90° C. In some embodiments, the LCST of the hygroscopic media can be at least about or under 25° C., at least about or under 30° C., or at least about or under 45° C. In certain embodiments, direct sunlight may be used that could heat the dilute hygroscopic media to a temperature of about 45° C. or higher. On the other hand, concentrated sunlight can be used to ramp up the desired temperature to reach the LCST of the dilute hygroscopic media, which in some examples may be up to about 75° C.

In the settling tank 124, complete or a portion of water-rich phase 130 may be separated from the hygroscopic media phase 104 and can be stored or used immediately. After the phase separation of hygroscopic media 104 that is diluted with captured water 130 in the absorber, the hygroscopic media 104 may be physically separated from the captured water 130. In some embodiments, the settling tank 124 promotes physical separation of hygroscopic media 104 and the captured water 130. For example, in some embodiments, the density of the hygroscopic media 104 above the LCST is higher than the density of captured water 130. When the dilute hygroscopic media 116 is phase separated, the captured water 130 may float on top or bottom of the hygroscopic media 104. When the dilute hygroscopic media 116 is phase separated in this manner, the captured water 130 can be poured or removed from the top or bottom of the separator 106. The captured water 130 may include a small amount of residual hygroscopic media 104, which can be removed using a secondary unit operation 122 downstream including, but are not limited to, centrifugation and/or membrane filtration. Rich hygroscopic media (concentrated hygroscopic media) 104 may be passed through the absorption chamber 102 again in a closed loop to absorb and/or adsorb more water 130 in certain embodiments. The hygroscopic media 104, or a mixture of the hygroscopic media and water (e.g., dilute hygroscopic media 116), may have a low viscosity such that it can be easily pumped through pipes of the AWG system 100 operable to perform the method as described herein. As an example, the mixture of the hygroscopic media and water may have a viscosity under 500 milliPascal-second (mPa·s) or in a range from about 1 mPa·s to about 30 mPa·s or up to about 50 mPa·s at operable conditions of the AWG system.

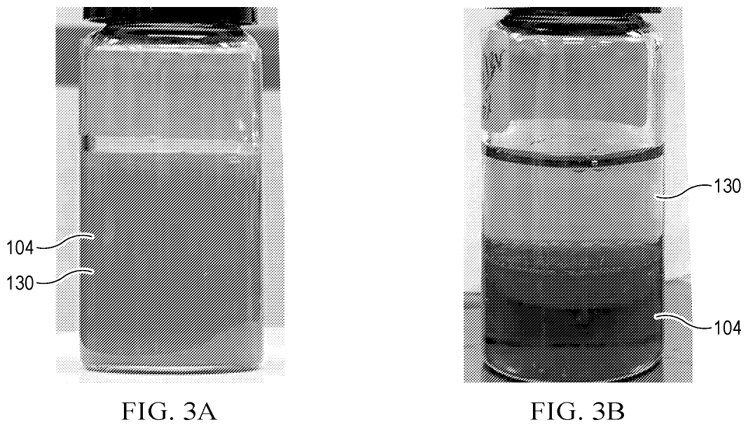

As an example, a homogenous hygroscopic thermo-responsive media at a given concentration undergoes a phase separation by increasing the solution temperature. Notably, this type of phase separation results in immiscible liquid phases without vaporization or latent energy consumption. An example of such a thermo-responsive two-phase system comprised of the hygroscopic thermo-responsive media 104 and water 130 is depicted in FIGS. 3A and 3B, in which phase separation is achieved without vaporizing the water with only a temperature swing of about 10 to 15° C. At a temperature below the LCST, the hygroscopic thermo-responsive media is soluble in water and forms a homogeneous solution or dilute hygroscopic media 116 (FIG. 3A). When heated to a temperature above the LCST, the homogeneous solution turns turbid initially and then separates into hygroscopic thermo-responsive media phase 104 at the bottom of the vial and a water phase 130 immiscible with it on top (FIG. 3B). After cooling, a single homogenous phase or dilute hygroscopic media 116 forms again (FIG. 3A). This depicts a phenomenon in which water destabilizes the thermodynamic equilibrium of separated phases, wherein the positive contribution of excess Gibbs energy of water decreases with an increased temperature. Here, the water hygroscopic media interaction would take precedence over water-water and hygroscopic media-hygroscopic media interactions, leading to the phase homogenization. To make the phase separation more clearly visible, Coomassie Brilliant Blue R-250 may be added to the solution. This temperature-induced mixing-demixing is thus fully reversible and has not been described for atmospheric water generation application before, where the hygroscopic thermo-responsive media can be recycled in a closed loop system for efficient water production.

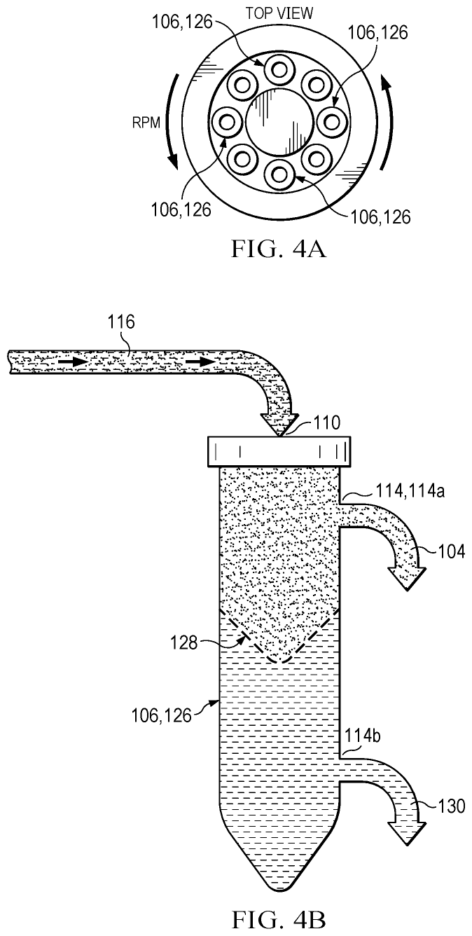

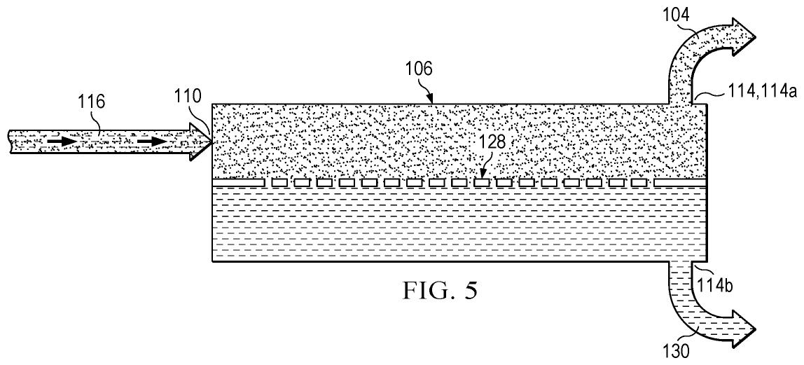

In certain embodiments, the two-phase liquid may be separated via centrifuging to separate the hygroscopic media 104 from captured water 130, as shown in FIG. 4. The separator or extraction unit 106 may comprise a centrifugation unit 126, which may be referred to as a centrifugation-driven liquid-liquid extractor 126, in which the dilute hygroscopic media 116 may be centrifuged at a desired rpm (rotations per minute). As an example, the rpm can be set at a speed at or under 17,000 g. In certain embodiments, the centrifugation time may be varied. In certain embodiments, the separation unit 106 is configured to be operated at a batch mode or a continuous style to fit the entirety of AWG system configuration. The centrifugation may be carried out at a temperature above the LCST, thereby allowing the dilute hygroscopic media 116 to phase separate into hygroscopic media 104 and captured water 130. In some embodiments, the density of the hygroscopic media 104 above the LCST is higher than the density of the captured water 130. When the dilute hygroscopic media 116 is phase separated, the captured water 130 floats on top (or bottom depending on density) of the hygroscopic media 104. When the dilute hygroscopic media 116 is phase separated in this manner, the captured water 130 can be poured or removed from the top of the container 106,126. In some embodiments, a porous membrane 128 having a hydrophilic (high affinity to water) or hydrophobic (low affinity to water) nature is used to expedite the separation process, wherein water molecules 130 are selectively separated from the hygroscopic media 104 at a temperature above the LCST. In some embodiments, selected membranes 128 may comprise a fabricated multi-layered structure including a selective layer and a protective layer, which may provide enhanced physical, chemical, mechanical, and/or thermal properties for improved performance and stability. Briefly, membranes 128 in an aqueous environment have an attractive or repulsive response to water. The material composition of the selected membrane 128 and its corresponding surface chemistry may determine its interaction with water. For example, when a hydrophilic membrane is used, water molecules are selectively allowed to pass through the membrane to the permeate side, and the hygroscopic media molecules, which are hydrophobic in nature at a temperature above the LCST, are retained on the retentate side of the membrane. In some examples, the hydrophilic membranes may include, but are not limited to, polyvinylpyrrolidone (PVP), polyethersulfone (PES), and/or polyacrylonitrile (PAN). Whereas when a hydrophobic membrane is used, the hygroscopic media molecules are allowed to pass through the membrane to the permeate side at a temperature above the LCST, and the extracted water is retained on the retentate side. In some examples, the hydrophobic membranes may include, but are not limited to, polyvinylidene difluoride (PVDF), polytetrafluoroethylene (PTFE), polysulfone (PS), and/or polypropylene (PP). In some embodiments, the pore size or molecular weight cutoff (MWCO) of membranes 128 is optimized in such a way that, it is configured to the rotation speed of centrifuge to avoid membrane damage. In certain embodiments, when porous hydrophilic membranes are used, the extracted water on the retentate side of a membrane may include a small amount of residual hygroscopic media; in such an example, the retentate may be washed one or more times with extracted water in a closed loop to further improve the purity of water collected.

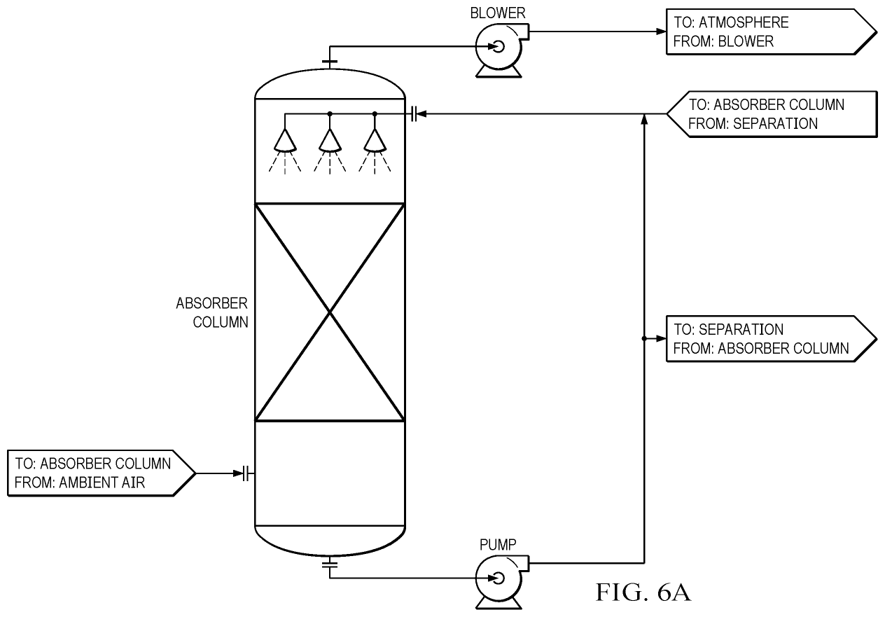

In certain embodiments, the two-phase liquid may be separated via a pressure-driven membrane configuration (FIG. 5), also utilizing a porous membrane 128. The separation or extraction unit 106 may comprise one or more nanofiltration membrane modules, wherein the dilute hygroscopic media 116 under the LCST is passed through a module at a desired pressure. In some embodiments, a pressure of about 3 bar to 10 bar, or about 15 bar or less, or about 5 bar or more, is used to push the captured water through the nanofiltration membrane and/or ultrafiltration. In some embodiments, selected membranes 128 may comprise a fabricated multi-layered structure including a selective layer and a protective layer, which may provide enhanced physical, chemical, mechanical, and/or thermal properties for improved performance and stability. In certain embodiments, the membrane module is configured to be operated at a batch mode or a continuous style to fit the entirety of AWG system configuration. The membrane separation may be carried out at a temperature above the LCST, thereby allowing the dilute hygroscopic media 116 to phase separate into the hygroscopic media phase 104 and the captured water phase 130. In some embodiments, the flow rates of process stream(s) are varied, which may improve the efficiency of separation. When the dilute hygroscopic media 116 is phase separated in this manner, the captured water 130 can be poured or removed from the bottom of the separator 106. As an example, a porous membrane 128 comprising hydrophilic (high affinity to water) or hydrophobic (low affinity to water) nature may be used to expedite the separation process, where water molecules 130 are selectively separated from the hygroscopic thermo-responsive media 104 at a temperature above the LCST. Briefly, membranes 128 in an aqueous environment have an attractive or repulsive response to water. The material composition of the selected membrane 128 and its corresponding surface chemistry may determine its interaction with water. For example, when a hydrophilic membrane is used, water molecules are selectively allowed to pass through the membrane to the permeate side, and the hygroscopic media molecules, which are hydrophobic in nature at a temperature above the LCST, are retained on the retentate side of a membrane. In some examples, the hydrophilic membranes may include, but are not limited to, polyvinylpyrrolidone (PVP), polyether sulfone (PES), and/or polyacrylonitrile (PAN). Whereas when a hydrophobic membrane is used, the hygroscopic fluid molecules are allowed to pass through the membrane to the permeate side at a temperature above the LCST, and the extracted water is retained on the retentate side. In some examples, the hydrophobic membranes may include, but are not limited to, polyvinylidene difluoride (PVDF), polytetrafluoroethylene (PTFE), polysulfone (PS), and/or polypropylene (PP). In some embodiments, the pore size or molecular weight cutoff (MWCO) of membranes 128 are optimized in such a way that, it is configured to the operating pressure to avoid membrane damage. In certain embodiments, when porous hydrophilic membranes are used, the extracted water on the retentate side of a membrane may include a small amount of residual hygroscopic media; in such an example, the retentate may be washed one or more times with extracted water in a closed loop to further improve the purity of water collected. In certain embodiments, the membrane module may be maintained at a temperature above the LCST of the hygroscopic thermo-responsive media which is concentration dependent. In some embodiments, the membrane module is maintained at a temperature of about under 90° C. In some embodiments, the LCST of the hygroscopic thermo-responsive media can be at least about or under 25° C., at least about or under 30° C., at least about or under 45° C. In certain embodiments, direct sunlight may be used that could elevate the temperature of the membrane module to about 45° C. or higher. On the other hand, concentrated sunlight can be used to ramp up the desired temperature to reach the LCST of the dilute hygroscopic media, which in some examples may be up to about 75° C.

In certain instances, hygroscopic media that is responsive to certain gases may be used. In such instances, the hygroscopic media may have additional functional groups added to the molecular structure, such that the hygroscopic media forms a two-phase liquid-liquid solution with the introduction of certain gases. Examples of gases that certain hygroscopic media are responsive to include nitrogen, carbon dioxide and oxygen. The hygroscopic media may also be responsive to other gases that are not listed. In certain instances, the hygroscopic media may be responsive to a plurality of gases that are introduced, such as nitrogen and oxygen. In certain instances, energy in the form of heat may also be added to the gas responsive media to help with the two-phase liquid-liquid separation.

In certain instances, hygroscopic media that is responsive to a magnetic field may be used. In such instances, a thermoresponsive magnetic hygroscopic media may be obtained by incorporating high-spin transition metal ions into the molecular structure of conventional hygroscopic media, such that the media forms a two-phase liquid-liquid solution with the introduction of a magnetic field. In some examples, constituents of the thermoresponsive magnetic hygroscopic media may include, but not limited to, octyltrimethylammonium bromotrichloroferrate, dodecyltrimethylammonium tetrachloroferrate, and/or 8-butyl-1,8-diazabicyclo[5.4.0]undec-7-ene bromotrichloroferrate. Their hygroscopic nature, together with thermo- and magnetic-responsive behaviors, make them promising candidates for atmospheric water generation.

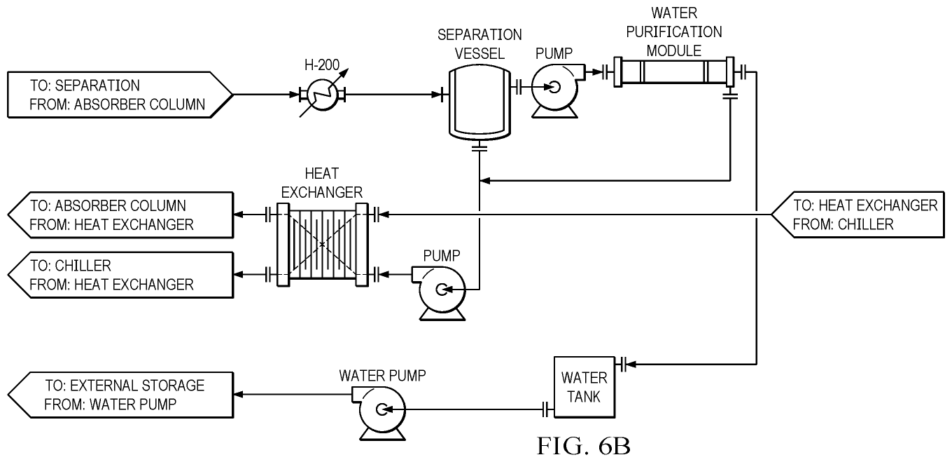

Referring now to FIGS. 6A-6B, in certain embodiments, the hygroscopic media may be brought into contact with humid air in an absorption chamber of an atmospheric air generation system as a part of a method of operating the same. In operation, ambient air (at an ambient temperature and an ambient humidity level) may be directed into the absorption chamber (also referred to herein as an absorber). In certain embodiments, a blower may be implemented at the air intake to the absorber to increase the volumetric flow rate of ambient air entering the absorber. In the absorber, the ambient air contacts a rich (concentrated) hygroscopic media, which may be provided to the absorber as a homogeneous fluid at a low temperature, whereby the vapor pressure within the absorber may decrease and water vapor within the humid ambient air may condense and be absorbed by the hygroscopic fluid. While the ambient air and the hygroscopic fluid flow through the absorber, humidity within the air may condense and/or be otherwise absorbed into the hygroscopic media to dilute the hygroscopic media and dry the air. The dry air may then exit the absorber back to the atmosphere. A blower may be incorporated at an ambient air exhaust of the absorber to increase the volumetric flow rate of air passing through the absorber. The blower may be provided in addition to, or as an alternative to, the above-mentioned blower placed at the ambient air intake of the absorber. Moreover, once the hygroscopic thermo-responsive fluid has passed through the absorber, a diluted, but still cool, hygroscopic fluid may exit the absorber. In certain embodiments the absorber may have a counter flow configuration where atmospheric air enters the absorber proximate to the bottom of the absorber. Dry, atmospheric air may then exit the absorber proximate the top of the absorber (with a pump/blower optionally utilized to move air through the absorber). Rich hygroscopic fluid may enter proximate the top of the absorber via flow path and flow down through the interior of the absorber due to gravity. Water may be absorbed from the ambient air into the hygroscopic fluid, such that dilute hygroscopic media may exit the absorber proximate to the bottom of the absorber. Flow modifiers, such as barriers, mesh, and/or turns in exit piping from the absorber may be used to reduce carry over of the hygroscopic fluid in the air exit of the absorber. The flow modifiers may be positioned in the interior of the absorber proximate to the top of the absorber (e.g., at a mouth of an exhaust port for dry ambient air to exit the absorber via flow path). In some examples, the absorber may operate in a cross-flow configuration where air enters the absorber from one side of the absorber and traverse (e.g., at least substantially horizontally) to the other side. Rich hygroscopic fluid media may enter the top of the absorber, absorb water from the ambient air as it flows to a low point in the absorber where dilute hygroscopic media exits proximate the bottom. In this fashion, the air flow may be at least substantially perpendicular to the flow of the hygroscopic fluid within the absorber. In this configuration, the air inlet and air outlet may be approximately at the same height on the absorber. In certain configurations, the absorber may be operated in a cross-counter flow configuration where air enters the absorber from one the side of the absorber and traverses to the other side. Rich hygroscopic fluid may enter proximate the top of the absorber and may absorb water from the ambient air as it flows to a low point in the absorber where dilute hygroscopic media may exit proximate the bottom of the absorber. In this configuration, the air inlet and air outlet may be offset in level from each other. In this configuration, the air inlet can be at the side of the absorber at a location proximate to the top of the absorber and the air outlet may be on the side of the absorber proximate to the bottom. In another orientation of this configuration, the air inlet may be positioned on the side of the absorber proximate to the bottom of the absorber and the air outlet may be positioned on the opposite side of the absorber proximate to the top of the absorber. As such, the air path may travel in an angled manner through the absorber from the top of the absorber to the bottom or from the bottom of the absorber to the top.

Referring again to FIG. 2, the interior of the absorber 102 may comprise a plurality of packing components 136 across which the rich hygroscopic media 104 may flow as it absorbs water 130 extracted from the humid ambient air 132. The packing components 136 may be provided to increase the surface area of the rich hygroscopic fluid 104 flowing within the absorber 102 and also to provide a highly tortuous flow path for ambient air 132 flowing through the absorber 102, such that the air 132 has a turbulent flow through the interior of the absorber 102. The absorber 102 may be embodied as a counter flow column described above, with the rich hygroscopic media 104 entering the absorber 102 at a hygroscopic column inlet 112 located at or near the top of the absorber 102, and the ambient air inlet 112b being located at the bottom of the absorber 102. The ambient air 132 may flow upwards to a dry air exhaust 108b located at or near the top of the absorber 102, and the hygroscopic fluid 104 may flow downward, across the packing components 136, to a dilute hygroscopic media fluid outlet 108 of the absorber 102. As examples, the packing components 136 may comprise individual blocks, balls, trays, baffles and/or any other shape defining a plurality of baffles, slits, holes, meshes, and/or other flow modifying components that may be positioned within the absorber 102 to collectively define a highly tortuous path for the ambient air 132 and the hygroscopic media 104 to pass through the absorber 102. The packing components 136 may comprise (be formed of) a material that is not reactive to the hygroscopic media 104. In certain embodiments, a plurality of packing components 136 may be positioned within the absorber 102 without physically connecting the packing components 136 relative to one another. In other embodiments, a single packing component sized and shaped specifically for the interior of the absorber may be provided and positioned within the absorber 102. The packing components 136 of certain embodiments may be placed in a structured configuration to define channels set at different angles to each other with or without holes that collectively define structured flow paths for the ambient air 132 and/or the hygroscopic media 104 flowing through the absorber 102. To provide a structured packing configuration, the packing components 136 may be placed in the absorber in an ordered stacked manner, as illustrated in FIG. 2. Packing components 136 can also be positioned randomly, e.g., a plurality of geometrically shaped components may be randomly placed in the absorber 102 to increase surface area. Although discussed as a packing-based absorber, it should be understood that the hygroscopic fluid 104 can be passed through the absorber via other configurations, such as by atomization of the liquid hygroscopic media, by spraying the hygroscopic media within the absorber, and/or the like.

Returning to FIGS. 6A and 6B, the dilute hygroscopic media (or “dilute hygroscopic fluid”) may exit the absorber to a pump. In certain operation, the absorber can be operated in a batch configuration where a series of valves may be configured to recirculate the dilute hygroscopic fluid along a flow path (while additional rich hygroscopic fluid is prevented from entering the closed loop while appropriate valves remain closed) and through a pre-absorber heat exchanger (e.g., a shell-and-tube heat exchanger, a plate heat exchanger, and/or the like) to cool the dilute hygroscopic fluid (the opposite side of the heat exchanger is cooled water that has been collected from the overall system) before it is passed back into the top of the absorber. In this way, the amount of water absorbed into the hygroscopic fluid may be increased (thereby increasing the level of dilution of the hygroscopic media) before the hygroscopic fluid is directed to separation portions of the overall system. In certain embodiments the absorber chamber may utilize rotating air with no packing material to encourage the mass transfer of water to the hygroscopic media. In certain instances, the chamber may be in the shape of a cone to allow for the interaction. In certain instances, it may be in a cylindrical shape. In certain embodiments the absorber chamber itself may be mechanically rotated to induce a hyper gravity environment to help with the absorption of water into and/or onto the hygroscopic rich fluid. In certain embodiments the absorber chamber may also be used as the separation chamber in which the function is changed after a certain amount of water has been absorbed. In certain embodiments, the pre-absorber heat exchanger is cooled using a chiller in which a cooling media such as water, glycol, and/or the like is used on the other side of the heat exchanger to cool the rich hygroscopic media along the flow path. The absorber can be operated in a continuous configuration where valves are configured to recirculate a portion of dilute hygroscopic media. In this configuration, a certain amount of dilute hygroscopic media may be recirculated to the input of the absorber via the pre-absorber heat exchanger (e.g., a shell-and-tube heat exchanger, a plate heat exchanger, and/or the like) to cool the dilute hygroscopic fluid (the opposite side of the heat exchanger may be cooled using water that has been collected from the overall system, as discussed in greater detail herein) before it is passed back into the top of the absorber. Another portion of the dilute hygroscopic fluid may simultaneously pass to a separator vessel, discussed herein. In certain embodiments, the absorber may be configured such that the rich hygroscopic fluid is not cooled in a heat exchanger. In this embodiment, cooling of the hygroscopic fluid may be provided via thermal conductive heat exchange with ambient air through the conductive pipes. Fluid cooling may be provided in the absorber as sensible heat exchange with the atmospheric air, provided that the air temperature is lower than the entering hygroscopic media temperature. In certain embodiments, the absorber may be configured such that the diluted fluid exits the absorber and is sent to the separation vessel without a recirculation path. Rich hygroscopic fluid returning from the separation vessel may or may not be cooled with a heat exchanger and/or chiller and/or geothermal cooling prior to entering the absorber. In other embodiments, Joule-Thompson-based cooling may be utilized (utilizing rapid changes in pressure of the hygroscopic media (or gases in contact with the hygroscopic media) to cool the hygroscopic media.

Referring again to FIG. 2, after the fluid has passed through the absorber 102, it may be sent along a flow path to the separation vessel 106. The separation vessel may include one or more energy exchanging devices 120, such as heat exchangers, heaters, thermal sinks, geothermal heaters, solar heaters, configured to increase the temperature of the hygroscopic media 104. In certain embodiments, the one or more energy exchanging devices 120 can reside within the interior and/or exterior of the separation vessel 106. In other embodiments, the one or more energy exchanging devices 120 may be embodied as separate devices provided in series along a flow path. In other embodiments, the separation vessel 106 may be jacketed to maintain the internal temperature of the vessel. Once the dilute hygroscopic fluid 116 passes through the energy exchanging device 120 and is raised above the critical temperature of the hygroscopic media 104, it may separate into two phases, one comprising the captured water 130 and one comprising the hygroscopic media 104. Due to a difference in density between the phases and the hydrophobicity of the hygroscopic fluid above the lower critical solution temperature, a bulk separation of the hygroscopic fluid 104 and the water 130 may occur. In certain embodiments, the energy exchange device 120 may be configured to cool the hygroscopic fluid below an upper critical solution temperature of the hygroscopic fluid. After being cooled, the dilute hygroscopic fluid 116 may separate into a water rich phase comprising the captured water 130 and a hygroscopic fluid rich phase comprising the hygroscopic media 104. Due to a difference in density between the phases and the hydrophobicity of the hygroscopic fluid below the upper critical solution temperature, a bulk separation of the hygroscopic fluid 104 and water 130 may occur. The separation vessel 106 may be configured to allow for a two-phase liquid-liquid separation of liquid water 130 absorbed to the hygroscopic fluid 104 and the hygroscopic fluid 104 itself. As such, one liquid phase (e.g., water 130) may be drawn off the top of the separation vessel 106 and another liquid phase (e.g., hygroscopic media 104) may be drawn off at the bottom of the separation vessel 106, as illustrated. In certain embodiments, the inlet to the separation vessel 106 may be proximate to the middle of the separation vessel 106. In other embodiments, the inlet to the separation vessel 106 may be proximate to the top of the separation vessel 106. In other embodiments, the inlet 110 to the separation vessel 106 may be proximate to the bottom of the separation vessel 106, as illustrated. In certain embodiments, the inlet 110 to the separation vessel 106 may be changed depending on the amount of separation desired.

In certain embodiments, the separation vessel 106 may comprise a vessel containing a plurality of horizontal plates, baffles, and/or the like. The plates may have through-holes extending through a top surface and a bottom surface of the plates to allow fluid to pass through. In certain embodiments, the plates may have a support rod that attaches to all plates in the separation vessel, for example, extending through the center of the plates. In certain embodiments, the rod may be rigidly connected to all of the plates and the rod may reciprocate within the vessel (e.g., up and down via an actuator) to cause agitation of the hygroscopic fluid in the separation vessel. In other embodiments, the separation vessel 106 may contain no plates and simply comprise a vessel with a single inlet and two outlets. In certain embodiments, the separation vessel 106 may contain a membrane with pore sizes to inhibit the flow of the hygroscopic fluid through the membrane while allowing water to traverse across the membrane. In this configuration, a pump may be used to increase the pressure of the entering hygroscopic fluid. In certain embodiments, the separation vessel may be of a micro scale and/or may be laser etched onto silicone (or other material) substrates. In this configuration, multiple separation vessels may be etched onto a single substrate. In this configuration, the separation vessel may form a T-shaped vessel. Multiple laser etched substrates may share a common inlet header. Streams from the T shaped vessel may be routed to a common outlet header.

In certain embodiments, the water rich hygroscopic fluid comprising the captured water 130 separated in the separation vessel 106 may be sent through another separation vessel having a configuration similar to the first separation vessel. This allows for further purification of the fluid. Water rich hygroscopic fluid may enter the separation vessel and again separate into two phases, for example, based at least in part on density and hydrophobicity. The water rich phase can be separated from the hygroscopic rich phase in the separation vessel. In certain embodiments, energy may be input through a single or plurality of energy exchanging devices, such as heat exchangers, heaters, thermal sinks, geothermal heaters, and/or solar heaters prior to entering the second separation vessel.

In certain embodiments, a gas responsive hygroscopic fluid may be used in the absorption chamber as described above to capture water from humid air. Once at least partially saturated (diluted), the hygroscopic fluid may be sent to the separation vessel. In certain embodiments, gas may be introduced into the hygroscopic fluid prior to the separation vessel. In this embodiment, piping for transporting the hygroscopic fluid may be cylindrical piping. In certain embodiments, obstacles such as baffles, packing, or material specifically designed to create turbulent and tortuous flow may be placed in the piping to encourage mixing of the gas with the hygroscopic fluid. In certain embodiments, the gas may be bubbled through the hygroscopic fluid in the separation vessel. In this instance, the gas may be introduced to the hygroscopic fluid proximate to the bottom of the separation vessel. Differences in density between the gas and the hygroscopic fluid may cause the gas to traverse upward through the hygroscopic fluid. In this embodiment, water rich hygroscopic fluid may be introduced to the separation vessel proximate to the middle of the vessel. In certain embodiments, the water rich hygroscopic fluid may be introduced to the separation vessel proximate to the top of the vessel. In certain embodiments, the water rich hygroscopic fluid may be introduced to the separation vessel proximate to the bottom of the vessel. In certain embodiments, the separation vessel may include actuated plates as described above. In certain embodiments, the separation vessel may comprise material specifically designed to create turbulent and tortuous flow of the gas upward through the separation vessel. Examples of this design include 3D printed structures that encourage the disaggregation of bubbles.

As described above, separation of the hygroscopic fluid from the water may occur in the separation vessel 106. Once the water rich liquid phase is separated from the hygroscopic fluid, it may be sent to another process for further purification of the fluid. This process may be another separation process in the form of membrane separation such as nano filtration, membrane distillation, mechanical vapor compression, distillation, reverse osmosis, electrodialysis and/or a combination of said technologies. As discussed above, such a purification process may ensure that all or substantially all of the hygroscopic fluid is captured and replenished to preserve the hygroscopic fluid. The hygroscopic rich liquid phase comprising the hygroscopic media 104 may leave the separation vessel 196 and be sent back to the absorber 102. Prior to entering the absorber 102, the hygroscopic fluid 104 may be sent through an energy exchanging device (e.g., chiller, heat exchanger, geothermal cooling loop, and/or the like) 122 to cool the hygroscopic fluid 104 below its critical temperature. The hygroscopic fluid 104 may then enter the absorber 102 as described above. In certain embodiments, the water rich hygroscopic fluid 104 that is removed from the separation vessel 106 may be sent to a subsequent vessel and/or vessels to allow for a multistage process.

Certain embodiments of an atmospheric water generation system as discussed herein may be configured for operating in a continuous operating mode, such that water is constantly or at least substantially constantly (during operation) extracted from humid air in an absorption chamber, while liquid water is being extracted from the hygroscopic fluid at an extraction (separation) chamber, such that the hygroscopic fluid flows between the chambers. In other embodiments, the atmospheric water generation system may be configured for a batch operation, for example, to accommodate differences in temperature during day and night and/or to accommodate differences in air humidity. As just one example, water may be extracted from the hygroscopic fluid through natural cooling of the hygroscopic fluid during lower night-time temperatures. In such instances, the hygroscopic fluid may be diluted during an absorption phase, and later water may be extracted from the hygroscopic fluid during an extraction phase. Moreover, certain embodiments may utilize waste heat from the water generation process and/or from third party industrial processes as a part of heat inputs to the water generation system discussed above. As just one example, heat produced from flared gases at oil or gas well heads may be utilized to provide input heat to the water generation process discussed above. As yet another embodiment, waste heat from electronics, such as heat produced by server farms, electrical equipment, and/or the like, may be utilized to heat the hygroscopic fluid while simultaneously providing needed heat transfer from the electronic equipment for optimal performance. In certain embodiments, the hygroscopic fluid, or more specifically, the chemical composition of the hygroscopic fluid, may be tuned to provide increased heat transfer characteristics, thereby providing efficient cooling for electronic equipment.

As discussed above, dry atmospheric air 134 may be exhausted to the atmosphere after water 130 is absorbed from the atmospheric air stream 132. In other embodiments, after water 130 is extracted from the air 132, the dry air 134 may be passed through one or more gas extraction stages 118. For example, a carbon dioxide extraction stage may be provided for extracting and capturing carbon dioxide from the air stream. As another example, oxygen may be extracted and captured from the air stream. As yet another example, argon may be extracted and captured from the air stream. In certain embodiments, each of a plurality of gases may be extracted via respective stages of the gas extraction process. These stages may be optimized to capture respective gases before others to increase the efficiency of gas capture. It is understood that certain gases may be more easily captured before or after humidity is extracted from the air. Moreover, it is understood that the chemical makeup of certain gases may facilitate extraction of those gases before others. Moreover, individual gas extraction stages 118 may be heated and/or cooled as needed to optimize gas capture.

The subject-matter of the disclosure may also relate to the following aspects:

A first aspect relates to an atmospheric water generation system 100 comprising: an absorption chamber 102 configured to facilitate absorption or adsorption of water 130 from atmospheric or ambient air 132 into and/or onto a hygroscopic media 104; and a separation vessel 106 in fluid communication with the absorption chamber 102 for extraction of absorbed or adsorbed water 130 from the hygroscopic media 104.

A second aspect relates to the atmospheric water generation system 100 of the first aspect, wherein the hygroscopic media 104 is responsive to changes in energy and/or to mixing with specific gases.

A third aspect relates to the atmospheric water generation system 100 of any preceding aspect, wherein the hygroscopic media 104 comprises an upper critical solution temperature (UCST) or a lower critical solution temperature (LCST), the hygroscopic media 104 being a hygroscopic thermo-responsive media.

A fourth aspect relates to the atmospheric water generation system 100 of the preceding aspect, wherein the LCST is at least about or under 25° C., at least about or under 30° C., or at least about or under 45° C., and/or up to about 75° C.

A fifth aspect relates to the atmospheric water generation system 100 of any preceding aspect, wherein the hygroscopic media 104 includes ionic liquid(s), polymer(s), organic solvent(s), and/or brine solution(s).

A sixth aspect relates to the atmospheric water generation system 100 of any preceding aspect, wherein the hygroscopic media 104, and/or the hygroscopic media 104 with the absorbed or adsorbed water 130, has a viscosity of less than about 500 milliPascal-second (mPa·s) at operable conditions of the atmospheric water generation system 100.

A seventh aspect relates to the atmospheric water generation system 100 of any preceding aspect, wherein an outlet 108 of the absorption chamber 102 is in fluid communication with an inlet 110 to the separation vessel 106, and wherein an inlet 112 of the absorption chamber 102 is in fluid communication with an outlet 114 of the separation vessel 106, thereby defining a closed loop for (a) delivery of a dilute hygroscopic media 116 comprising the hygroscopic media 104 with the absorbed or adsorbed water 130 to the separation vessel 106, and (b) return of the hygroscopic media 104 to the absorption chamber 102 after extraction of the absorbed or adsorbed water 130.

An eighth aspect relates to the atmospheric water generation system 100 of the preceding aspect, wherein the inlet 112 of the absorption chamber 102 is a first inlet 112a for introducing the hygroscopic media 104 to the absorption chamber 102, wherein the outlet 108 of the absorption chamber 102 is a first outlet 108a for removing the dilute hygroscopic media 116 from the absorption chamber, and wherein the absorption chamber 102 further comprises: a second inlet 112b for introducing the atmospheric or ambient air 132 into the absorption chamber 102; and a second outlet 108b for removing dry air 134 from the absorption chamber 102.

A ninth aspect relates to the atmospheric water generation system 100 of the preceding aspect, further comprising a gas extraction stage 118 in fluid communication with the second outlet 108b of the absorption chamber 102 for removing one or more gases from the dry air.

A tenth aspect relates to the atmospheric water generation system 100 of any one of the seventh through the ninth aspects, wherein the separation vessel 106 is configured for heating, and/or cooling, and/or wherein an energy exchanging device 120 is positioned between the outlet 108 of the absorption chamber and the inlet 110 to the separation vessel 106 for heating the dilute hygroscopic media 116.

An eleventh aspect relates to an atmospheric water generation system 100 of any one of the seventh through the tenth aspects, further comprising an energy exchanging device 122 positioned between the outlet 114 of the separation vessel 106 and the inlet 112 of the absorption chamber 102 for cooling the hygroscopic media 104 prior to the return to the absorption chamber 102.

A twelfth aspect relates to the atmospheric water generation system 100 of any one of the seventh through the eleventh aspects, wherein the outlet 114 of the separation vessel is a first outlet 114a, and wherein the separation vessel 106 further comprises a second outlet 114b for removal of the absorbed or adsorbed water 130 after the extraction.

A thirteenth aspect relates to the atmospheric water generation system 100 of any preceding aspect, wherein the absorption chamber 102 contains one or more packing components 136 configured to modify flow of the atmospheric or ambient air 132 and/or flow of the hygroscopic media 104.

A fourteenth aspect relates to the atmospheric water generation system 100 of any preceding aspect, wherein the absorption chamber 102 is configured to utilize rotating air.

A fifteenth aspect relates to the atmospheric water generation system 100 of any preceding aspect, wherein the separation vessel 106 comprises a settling tank 124.

A sixteenth aspect relates to the atmospheric water generation system of any preceding aspect, wherein the separation vessel 106 comprises a centrifugation-driven liquid-liquid extractor 126.

A seventeenth aspect relates to the atmospheric water generation system 100 of any preceding aspect, wherein the separation vessel 106 contains a porous membrane 128.

An eighteenth aspect relates to the atmospheric water generation system 100 of the preceding aspect, wherein the porous membrane 128 is hydrophilic.

A nineteenth aspect relates to the atmospheric water generation system 100 of the seventeenth or eighteenth aspect, wherein the porous membrane 128 comprises polyvinylpyrrolidone (PVP), polyethersulfone (PES), and/or polyacrylonitrile (PAN).

A twentieth aspect relates to the atmospheric water generation system 100 of the seventeenth aspect, wherein the porous membrane 128 is hydrophobic.

A twenty-first aspect relates to the atmospheric water generation system 100 of the preceding aspect, wherein the porous membrane 128 comprises polyvinylidene difluoride (PVDF), polytetrafluoroethylene (PTFE), polysulfone (PS), and/or polypropylene (PP).

A twenty-second aspect relates to a method of producing clean water using the atmospheric water generation system 100 of any preceding aspect.

A twenty-third aspect relates to a method for the generation of water from moisture-laden gas, the method comprising: introducing a stream of moisture-laden gas into a hygroscopic liquid media 104, where the moisture-laden gas is preferably sourced from ambient atmospheric air 132, the hygroscopic liquid media 104 comprises an upper critical solution temperature (UCST) or a lower critical solution temperature (LCST); maintaining a temperature of the hygroscopic liquid media above its UCST or below its LCST, while introducing the moisture-laden gas, for a period of time to allow the hygroscopic liquid media 104 to absorb water 130 from the moisture-laden gas, thereby forming a homogenous, water-laden, hygroscopic liquid media (or dilute hygroscopic media) 116; decreasing the temperature of the water-laden or dilute hygroscopic liquid media 116 to a temperature below its UCST, thereby causing the water 130 to form a separate phase from the hygroscopic liquid media 104, or increasing the temperature of the water-laden or dilute hygroscopic liquid 116 media to a temperature above its LCST, thereby causing the water 130 to form a separate liquid phase from the hygroscopic liquid media 104; and extracting the liquid water 130.

A twenty-fourth aspect relates to the method of the preceding aspect, wherein the stream of moisture-laden gas (e.g., ambient air 132) is introduced into the hygroscopic liquid media 104 in a first (absorption) vessel 102, the homogenous, water-laden or dilute hygroscopic liquid media 116 is withdrawn from the first vessel 102 and transferred to a second (separation) vessel 106, and the temperature of the homogenous, water-laden or dilute hygroscopic liquid media 116 is decreased or increased after removal from the first (absorption) vessel 102.

A twenty-fifth aspect relates to the method of any preceding aspect, wherein the water-laden or dilute hygroscopic media 116 is sent to a subsequent vessel and/or vessels to allow for further separation of the hygroscopic media 104 from the water 130 and forming a multistage separation process.

A twenty-sixth aspect relates to the method of any preceding aspect, wherein the water is extracted by passing through a separation membrane 128 that is impermeable to the hygroscopic liquid media 104.

A twenty-seventh aspect relates to the method of any preceding aspect, wherein the liquid water 130 is extracted by allowing the water-laden or dilute hygroscopic liquid media 116 to separate into two liquid phases by gravity settling (e.g., in a settling tank 124) and then drawing off the liquid water phase 130.

A twenty-eighth aspect relates to the method of any preceding aspect, further comprising centrifuging the water-laden or dilute hygroscopic liquid media 116 to facilitate the separation of the liquid water phase 130 from the hygroscopic liquid media phase 104.

A twenty-ninth aspect relates to the method of any preceding aspect, wherein the hygroscopic liquid media 104 comprises ionic liquid(s), polymer(s), organic solvent(s), and/or brine solution(s).

A thirtieth aspect relates to the method of any preceding aspect, wherein the hygroscopic liquid media 104 comprises tetrabutylphosphonium bromide, tetrabutylphosphonium chloride, tetrabutylphosphonium trifluoroacetate, tributyl(octyl)phosphonium bromide, poly(N-isopropylacrylamide), 1-hexyl-3-methylimidazolium Bromide, tributylhexylphosphonium bromide, 1,3-dimethylimidazolium iodide tetrabutylphosphonium 2,4 dimethylbenzenesulfonate, tetrabutylphosphonium trifluoroacetate, tetrabutylphosphonium mesitylene sulfonate, tributyloctylphosphonium bromide, tetrabutylphosphonium p-toluenesulfonate, tetrabutylphosphonium N-trifluoromethanesulfonyl leucine, [N₄₄₄₄][TMBS], [N₄₄₄₄]CF₃COO, [P₄₄₄₄][Sal], [P₄₄₄₄][SS], or [N₄₄₄₄]CF₃COO, [P₄₄₄₄][Mal], or mixtures thereof.

A thirty-first aspect relates to the method of any preceding aspect, further comprising, after extracting the liquid water 130 from the water-laden hygroscopic liquid media 116, increasing the temperature of the hygroscopic liquid media to a temperature above its UCST, or decreasing the temperature of the hygroscopic liquid media to a temperature below its LCST, and introducing additional moisture-laden gas (e.g., ambient air 132) to the hygroscopic liquid media 104.

A thirty-second aspect relates to the method of any preceding aspect, wherein a change in temperature between the increasing and decreasing the temperature of the hygroscopic liquid media 104 to above and below its UCST or between the decreasing and increasing the temperature of the hygroscopic liquid media 104 to below and above its LCST is less than 25° C. temperature change, preferably less than 15° C. temperature change, or more preferably less than 10° C. temperature change.

A thirty-third aspect relates to the method of any preceding aspect, wherein a maximum temperature of the hygroscopic liquid media 104 during the method is less than 90° C., preferably less than 75° C., more preferably less than 60° C.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. An atmospheric water generation system comprising:
an absorption chamber configured to facilitate absorption or adsorption of water from atmospheric or ambient air into and/or onto a hygroscopic media; and
a separation vessel in fluid communication with the absorption chamber for extraction of absorbed or adsorbed water from the hygroscopic media.

2. (canceled)

3. The atmospheric water generation system of claim 1, wherein the hygroscopic media comprises an upper critical solution temperature (UCST) or a lower critical solution temperature (LCST), the hygroscopic media being a hygroscopic thermo-responsive media.

4. (canceled)

5. The atmospheric water generation system of claim 1, wherein the hygroscopic media includes ionic liquid(s), polymer(s), organic solvent(s), and/or brine solution(s).

6. (canceled)

7. The atmospheric water generation system of claim 1,
wherein an outlet of the absorption chamber is in fluid communication with an inlet to the separation vessel, and
wherein an inlet of the absorption chamber is in fluid communication with an outlet of the separation vessel,
thereby defining a closed loop for (a) delivery of a dilute hygroscopic media comprising the hygroscopic media with the absorbed or adsorbed water to the separation vessel, and (b) return of the hygroscopic media to the absorption chamber after extraction of the absorbed or adsorbed water.

8. The atmospheric water generation system of claim 7, wherein the inlet of the absorption chamber is a first inlet for introducing the hygroscopic media to the absorption chamber,
wherein the outlet of the absorption chamber is a first outlet for removing the dilute hygroscopic media from the absorption chamber, and
wherein the absorption chamber further comprises:
a second inlet for introducing the atmospheric or ambient air into the absorption chamber; and
a second outlet for removing dry air from the absorption chamber.

9. (canceled)

10. The atmospheric water generation system of claim 7, wherein the separation vessel is configured for heating, and/or
wherein an energy exchanging device is positioned between the outlet of the absorption chamber and the inlet to the separation vessel for heating the dilute hygroscopic media.

11. The atmospheric water generation system of claim 7, further comprising an energy exchanging device positioned between the outlet of the separation vessel and the inlet of the absorption chamber for cooling the hygroscopic media prior to the return to the absorption chamber.

12. The atmospheric water generation system of claim 7, wherein the outlet of the separation vessel is a first outlet, and
wherein the separation vessel further comprises a second outlet for removal of the absorbed or adsorbed water after the extraction.

13. The atmospheric water generation system of claim 1, wherein the absorption chamber contains one or more packing components configured to modify flow of the atmospheric or ambient air and/or flow of the hygroscopic media.

14. (canceled)

15. The atmospheric water generation system of claim 1, wherein the separation vessel comprises a settling tank.

16. The atmospheric water generation system of claim 1, wherein the separation vessel comprises a centrifugation-driven liquid-liquid extractor.

17. The atmospheric water generation system of claim 1, wherein the separation vessel contains a porous membrane.

18-21. (canceled)

22. A method of producing clean water using the atmospheric water generation system of claim 1.

23. A method for the generation of water from moisture-laden gas, the method comprising:
introducing a stream of moisture-laden gas into a hygroscopic liquid media, the hygroscopic liquid media comprises an upper critical solution temperature (UCST) or a lower critical solution temperature (LCST);
maintaining a temperature of the hygroscopic liquid media above its UCST or below its LCST, while introducing the moisture-laden gas, for a period of time to allow the hygroscopic liquid media to absorb water from the moisture-laden gas, thereby forming a homogenous, water-laden, hygroscopic liquid media;
decreasing the temperature of the water-laden, hygroscopic liquid media to a temperature below its UCST thereby causing the water to form a separate liquid water phase from the hygroscopic liquid media, or increasing the temperature of the water-laden, hygroscopic liquid media to a temperature above its LCST thereby causing the water to form a separate liquid water phase from the hygroscopic liquid media; and
extracting the liquid water.

24. The method of claim 23, wherein
the stream of moisture-laden gas is introduced into the hygroscopic liquid media in a first vessel,
the homogenous, water-laden, hygroscopic liquid media is withdrawn from the first vessel and transferred to a second vessel, and
the temperature of the homogenous, water-laden, hygroscopic liquid media is decreased or increased after removal from the first vessel.

25-27. (canceled)

28. The method of claim 23, further comprising centrifuging the water-laden hygroscopic liquid media to facilitate the separation of the liquid water phase from the hygroscopic liquid media phase.

29. The method of claim 23, wherein the hygroscopic liquid media comprises ionic liquid(s), polymer(s), organic solvent(s), and/or brine solution(s).

30. (canceled)

31. The method of claim 23, further comprising, after extracting the liquid water from the water-laden hygroscopic liquid media, increasing the temperature of the hygroscopic liquid media to a temperature above its UCST, or decreasing the temperature of the hygroscopic liquid media to a temperature below its LCST, and introducing additional moisture-laden gas to the hygroscopic liquid media.

32. The method of claim 23, wherein a change in temperature between the increasing and decreasing the temperature of the hygroscopic liquid media to above and below its UCST or between the decreasing and increasing the temperature of the hygroscopic liquid media to below and above its LCST is less than 25° C. temperature change.

33. The method of claim 23, wherein a maximum temperature of the hygroscopic liquid media during the method is less than 90° C.
